(19) United States
(12) Patent Application Publication
(10) Pub. No.: US 2018/0095960 A1
(43) Pub. Date: Apr. 5, 2018

(54) AUTOMATICALLY UPLOADING IMAGE FILES BASED ON IMAGE CAPTURE CONTEXT

(71) Applicant: Microsoft Technology Licensing, LLC., Redmond, WA (US)

(72) Inventor: Chia-Jiun Tan, Bellevue, WA (US)

(73) Assignee: Microsoft Technology Licensing, LLC., Redmond, WA (US)

(21) Appl. No.: 15/288,761

(22) Filed: Oct. 7, 2016

Related U.S. Application Data
(60) Provisional application No. 62/404,118, filed on Oct. 4, 2016.

(51) Int. Cl. G06F 17/30; G06F 3/0481

(52) U.S. Cl. CPC G06F 17/3028; G06F 17/30091; G06F 17/30117; G06F 3/04817; G06F 17/30126

(57) ABSTRACT

The present disclosure describes a system and method to manage image file storage that includes a memory device to store instructions and at least one processing device to execute the instructions stored in the memory device to determine an image capture context for an image, identify an image type corresponding to the image based at least in part on the image capture context, associate the image type with the image, and automatically store a copy of the image on a remote memory device based at least in part on the image type.

### PRIORITY INFORMATION

The present disclosure claims priority to provisional patent application Ser. No. 62/404,118, filed Oct. 4, 2016, titled Automatically Uploading Image Files Based on Image Capture Context, which is incorporated herein in its entirety.

### TECHNICAL FIELD

The present disclosure relates to image file storage and, more particularly, to automatically uploading image files based on image capture context.

### BACKGROUND

Mobile devices have become ubiquitous largely due to their impressive computing ability enclosed in a relatively small and portable footprint. Mobile devices may include hardware and software to capture still or moving images files, e.g., photographs and videos. Once captured, mobile devices may store the image files on local memory resident on the device itself. Local memory may encompass fixed memory and removable memory, e.g., memory cards. Local memory, however, is immutable, finite, and set at device manufacture creating a situation in which image files may need to be moved from the local memory to other, perhaps, remote memory for permanent storage before new images may be captured. Cloud file hosting service providers may offer remote memory to user accounts for such purposes based on a tiered system. A higher tier purchased for a higher price may buy a higher allotment of remote memory to a user account relative to a lower tiered account. As the hardware and software to capture images in mobile devices improves, image file size increases, in turn, challenging finite local memory or remote memory allocation for a particular tier. A need remains, therefore, for an improved method or system to manage image file storage.

### SUMMARY

The present disclosure describes a system and method to manage image file storage based on image capture context. An exemplary system may comprise a memory device to store instructions and at least one processing device to execute the instructions stored in the memory device to determine an image capture context for an image, identify an image type corresponding to the image based at least in part on the image capture context, associate the image type with the image, and automatically store a copy of the image on a remote memory device based at least in part on the image type.

The at least one processing device may execute the instructions stored in the memory device further to associate the image type with a corresponding account type at the remote memory device and automatically store the copy of the image in association with the corresponding account type on the remote memory device.

The at least one processing device may execute the instructions stored in the memory device further to store application metadata identifying the image type and the account type and automatically store the copy of the image in association with the corresponding account type on the remote memory device based on the metadata.

The at least one processing device may execute the instructions stored in the memory device further to identify the image type as a business type or a personal type and automatically store the copy of the image in association with an account type in the remote location account corresponding to the business type or the personal type.

The at least one processing device may execute the instructions stored in the memory device further to graphically display an image type icon to switch the image type from the business type to the personal type or vice versa.

The at least one processing device may execute the instructions stored in the memory device further to store the image at least temporarily in a local memory device after capturing the image and delete the image from the local memory device after automatically storing a copy of the image on the remote memory device.

In an exemplary system the remote memory device may be located geographically remote from the local memory device.

The at least one processing device may execute the instructions stored in the memory device further to graphically display a confirmation icon to confirm the automatic storage of the copy of the image.

An exemplary method may comprise determining, at a processing device, an image capture context for an image, identifying, at the processing device, an image type corresponding to the image based at least in part on the image capture context, generating, by the processing device, an enhanced image by including the image type in the image, and transmitting the enhanced image from the processing device to a remote memory device for automatic storage of the enhanced image on the remote memory device based at least in part on the image type.

The exemplary method may further comprise associating, by the processing device, the image type with a corresponding account type at the remote memory device and transmitting the enhanced image from the processing device to the remote memory device for automatic storage of the enhanced image on the remote memory device in association with the corresponding account type.

The exemplary method may further comprise identifying, by the processing device, the enhanced image by including the account type.

The exemplary method may further comprise identifying, by the processing device, the image type as a business type or a personal type and transmitting the enhanced image from the processing device to the remote memory device for automatic storage of the enhanced image on the remote memory device in association with an account corresponding to the business type or the personal type.

The exemplary method may further comprise graphically displaying, by the processing device, an image type icon to switch the image type from the business type to the personal type or vice versa and modify the enhanced image based at least in part on receiving an indication of actuation of the image type icon.

The exemplary method may further comprise storing the image or the enhanced image at least temporarily in a local memory device after capturing the image and delete the image from the local memory device after transmitting the enhanced image for automatic storage of the enhanced image in the remote memory device.

An exemplary computer-readable storage medium may comprise instructions that, when executed by one or more processing devices, cause the one or more processing devices to determine an image capture context for an image, identify an image type corresponding to the image based at least in part on the image capture context, generate an enhanced image by including the image type in the image, and transmit the enhanced image to a remote memory device for automatic storage of the enhanced image on the remote memory device based at least in part on the image type.

The exemplary computer-readable storage medium may further comprise associating the image type with a corresponding account type at the remote memory device and transmitting the enhanced image to the remote memory device for automatic storage of the enhanced image on the remote memory device in association with the corresponding account type.

The exemplary computer-readable storage medium may further comprise modifying the enhanced image by including the account type.

The exemplary computer-readable storage medium may further comprise identifying the image type as a business type or a personal type and transmitting the enhanced image to the remote memory device for automatic storage of the enhanced image on the remote memory device in association with an account corresponding to the business type or the personal type.

The exemplary computer-readable storage medium may further comprise graphically displaying an image type icon to switch the image type from the business type to the personal type or vice versa and modifying the enhanced image based at least in part on receiving an indication of actuation of the image type icon.

The exemplary computer-readable storage medium may further comprise storing the image or the enhanced image at least temporarily in a local memory device after capturing the image and deleting the image or the enhanced image from the local memory device after transmitting the enhanced image for automatic storage of the enhanced image in the remote memory device.

### BRIEF DRAWINGS DESCRIPTION

The present disclosure describes various embodiments that may be understood and fully appreciated in conjunction with the following drawings:

FIGS. 1A and 1B schematically illustrate a block diagram of an exemplary system, in accordance with some embodiments;

FIG. 1C schematically illustrates block diagram of an exemplary image capture device, in accordance with some embodiments;

FIG. 1D schematically illustrates block diagram of an exemplary image manager, in accordance with some embodiments;

FIGS. 2A and 2B illustrate a block diagram of an exemplary method for automatically uploading image files based on image capture context, in accordance with some embodiments;

FIGS. 3A-3C illustrate an exemplary graphical user interface (GUI) for automatically uploading image files based on image capture context, in accordance with some embodiments;

FIGS. 4A and 4B illustrates an exemplary graphical user interface (GUI) for automatically uploading image files based on image capture context, in accordance with some embodiments; and

FIG. 5 illustrates an exemplary graphical user interface (GUI) for automatically uploading image files based on image capture context, in accordance with some embodiments.

### DETAILED DESCRIPTION

The present disclosure describes embodiments with reference to the drawing figures listed above. Persons of ordinary skill in the art will appreciate that the description and figures illustrate rather than limit the disclosure and that, in general, the figures are not drawn to scale for clarity of presentation. Such skilled persons will also realize that many more embodiments are possible by applying the inventive principles contained herein and that such embodiments fall within the scope of the disclosure which is not to be limited except by the claims.

A cloud file hosting service provider, e.g., cloud storage service, online file storage provider, cyberlocker, or the like, is a global network-based hosting service for storing user files. In an embodiment, a file hosting service allows users to upload files from a local computing device, e.g., desktop computer, laptop, tablet, mobile device, or the like, to a remote computing device, e.g., a server, using a global network such as the Internet. The remote computing device may be associated with any number or type of memory devices or storage mediums to store the uploaded files. Doing so, allows access to the files to any computing device connected to the global network at any time.

A cloud file hosting service may store data, video, image, or any other type of electronic data in any of the memory devices. A cloud file hosting service maybe tailored to individuals or to business entities either free or for a price. Individuals may upload and share files with others often using password protection. Similarly, business entities may allow individuals in their employ access to certain files, often after authentication, from any computing device connected to the global network. Cloud file hosting services may allow user to share and collaborate on document files, e.g., word processor documents or excel spreadsheets. A cloud file hosting service may allow one or more users to share a single file, and synchronize the file across all devices or users at periodic intervals or otherwise. A cloud file hosting service may offer remote storage to individual users or business entities based on a tiered system, in turn, based on an amount of storage capacity, e.g., 1 Gb for free, 10 Gb for $50/month, and so on. A higher tier purchased for a higher price may buy a higher allotment of remote storage to a business account relative to a lower tiered free personal account.

A cloud file storage service may provide certain advantages compared to local file storage. For example, a file storage service allows access to files from any device connected to the global network at any time. A file storage service frees up local finite storage on devices with limited local memory, e.g., mobile devices, tablets, and the like. A file storage service may provide secure file storage, often with redundant backup. A file storage service may allow a business entity to control storage costs more precisely by contracting for certain amount of remote storage for a set monthly price or by agreeing to pay only for the remote storage the business actually uses in a given time period. A file storage service allows a business to cut their energy consumption by not having to cool and otherwise maintain on-premises storage devices. A file storage service may provide for natural disaster proof backup, as the service typically redundantly backups files in different geographic locations around the world.

A single user may have access to any number and type of accounts on a cloud file storage service. A single user may have access to, e.g., a personal account and a business account on a file storage service in which to store files remotely. In an embodiment, the business account may be provided by the user's employer or other business entity. The disclosure below describes automatically uploading image files from a computing device to the personal account or the business account on the file storage service based on a context of the image file at capture. For example, an image captured during work day hours, at a work location, or at a work meeting may be automatically uploaded to the user's business account. In contrast, an image captured image outside of work hours or at a non-work location may be automatically uploaded to the user's personal account. A user may have the ability to confirm the destination of the automatic upload to the personal or business account using a graphical device, icon, or otherwise as is explained in more detail below.

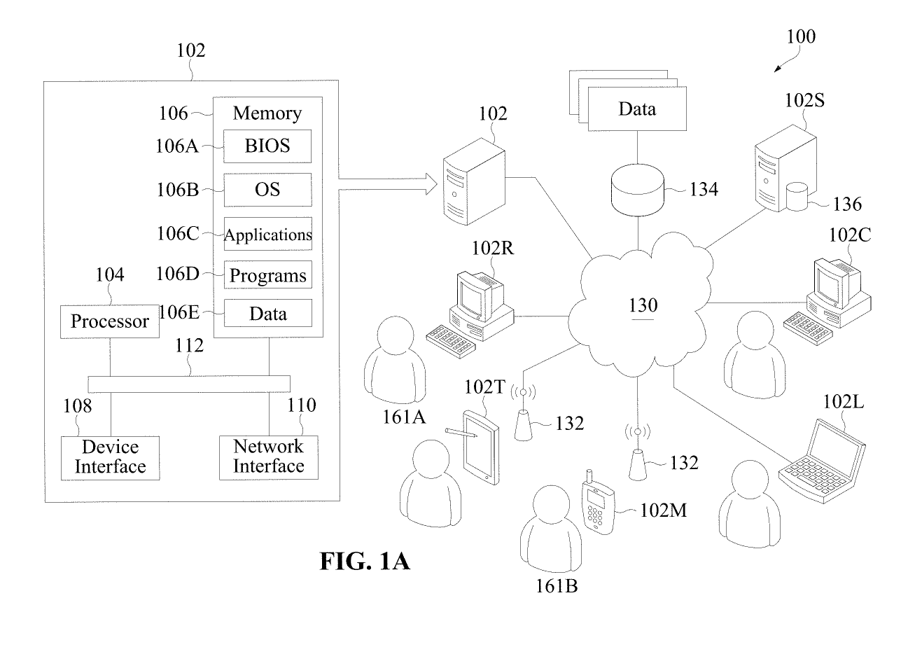

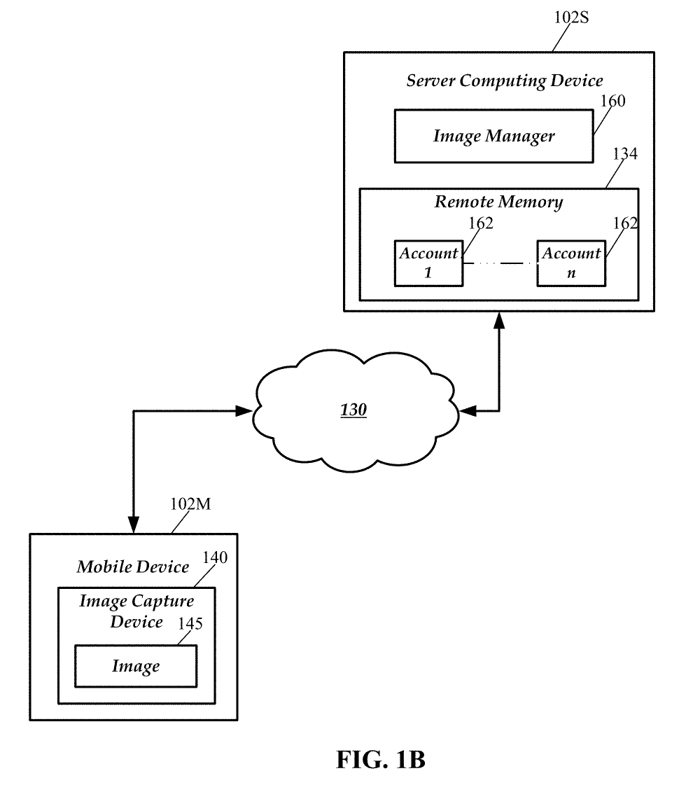

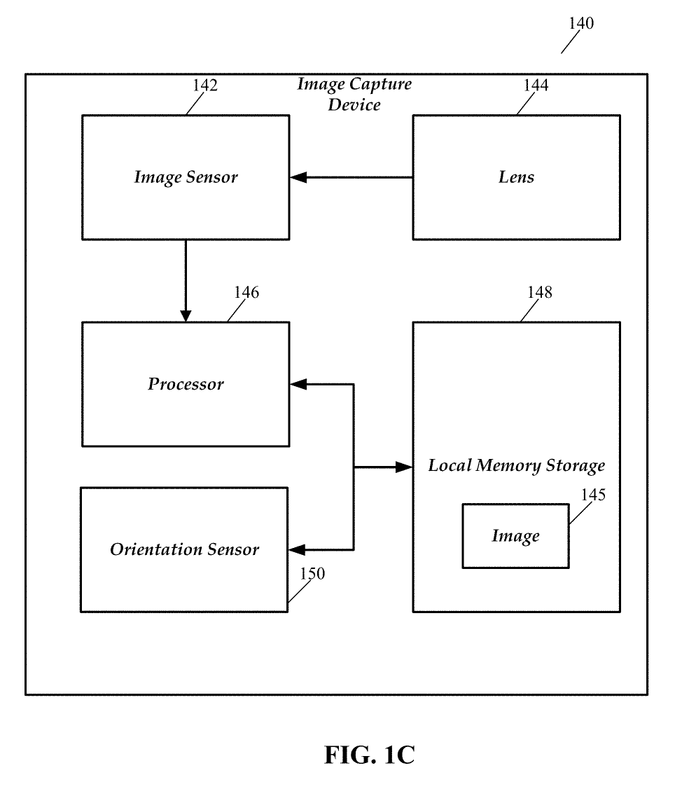

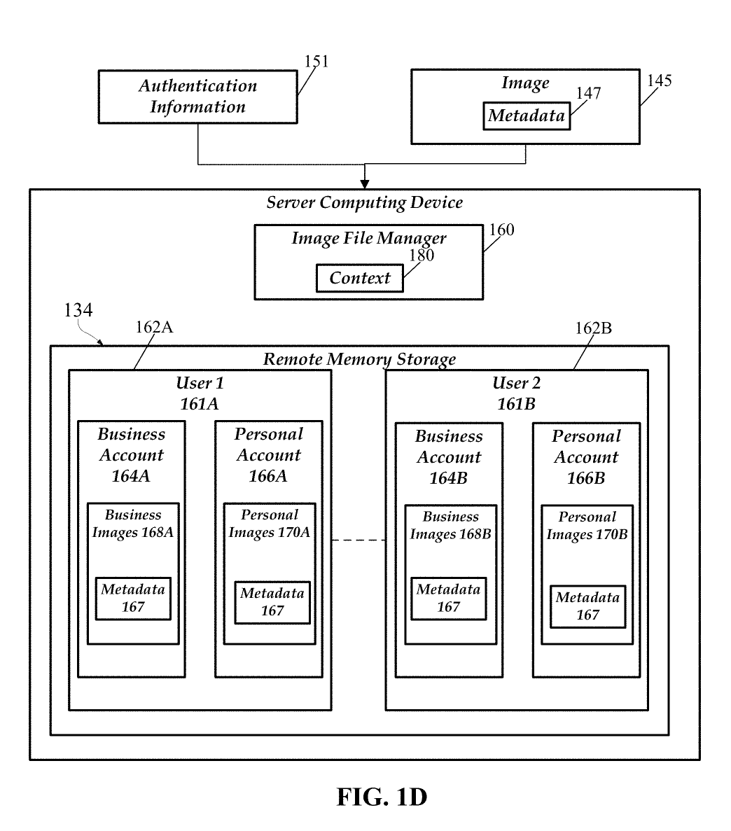

FIGS. 1A and 1B schematically illustrate a block diagram of an exemplary system 100, in accordance with some embodiments. Referring to FIGS. 1A and 1B, system 100 includes a computing device 102 that may execute instructions defining components, objects, routines, programs, instructions, data structures, virtual machines, and the like that perform particular tasks or functions or that implement particular data types. Instructions may be stored in any computer-readable storage medium known to a person of ordinary skill in the art, e.g., system memory 106, remote memory 134, or external memory 136. Some or all of the programs may be instantiated at run time by one or more processors comprised in a processing unit, e.g., processing device 104. A person of ordinary skill in the art will recognize that many of the concepts associated with the exemplary embodiment of system 100 may be implemented as computer instructions, firmware, hardware, or software in any of a variety of computing architectures, e.g., computing device 102, to achieve a same or equivalent result.

Moreover, a person of ordinary skill in the art will recognize that the exemplary embodiment of system 100 may be implemented on other types of computing architectures, e.g., general purpose or personal computers, hand-held devices, mobile communication devices, gaming devices, music devices, photographic devices, multi-processor systems, microprocessor-based or programmable consumer electronics, minicomputers, mainframe computers, application specific integrated circuits, and like. For illustrative purposes only, system 100 is shown in FIG. 1A to include computing devices 102, server computing device 102S, client computing device 102C, geographically remote computing devices 102R, tablet computing device 102T, mobile computing device 102M, and laptop computing device 102L. A person of ordinary skill in the art may recognize that computing device 102 may be embodied in any of tablet computing device 102T, mobile computing device 102M, or laptop computing device 102L. Mobile computing device 102M may include mobile cellular devices, mobile gaming devices, mobile reader devices, mobile photographic devices, and the like.

A person of ordinary skill in the art will recognize that an exemplary embodiment of system 100 may be implemented in a distributed computing system in which various computing entities or devices, often geographically remote from one another, e.g., computing device 102 and remote computing device 102R or server computing device 102S and client computing device 102C, perform particular tasks or execute particular objects, components, routines, programs, instructions, data structures, and the like. For example, the exemplary embodiment of system 100 may be implemented in a server/client configuration connected via a global network 130 (e.g., server computing device 102S may operate as a server and client computing device 102C or tablet computing device 102T may operate as a client, all connected through network 130). In distributed computing systems, application programs may be stored in and/or executed from local memory 106, external memory 136, or remote memory 134. Local memory 106, external memory 136, or remote memory 134 may be any kind of memory, volatile or non-volatile, removable or non-removable, known to a person of ordinary skill in the art including non-volatile memory, volatile memory, random access memory (RAM), flash memory, read only memory (ROM), ferroelectric RAM, magnetic storage devices, optical discs, or the like. Local memory 106, external memory 136, or remote memory 134 may be one or more individual memory devices of any type.

Computing device 102 may comprise processing device 104, memory 106, device interface 108, and network interface 110, which may all be interconnected through bus 112. Processing device 104 may be embodied in a single, central processing unit, or a plurality of processing units in a single or two or more computing devices 102, e.g., computing device 102 and remote computing device 102R. Processing device 104 may be any type of processing device, having any type of speed, capacity, functionality, or otherwise known to a person of ordinary skill in the art. Local memory 106, as well as external memory 136 or remote memory 134, may be any type memory device known to a person of ordinary skill in the art including any combination of RAM, flash memory, ROM, ferroelectric RAM, magnetic storage devices, optical discs, and the like that is appropriate for the particular task. Local memory 106 may store a database, indexed or otherwise. Local memory 106 may store a basic input/output system (BIOS) 106A with routines executable by processing device 104 to transfer data, including data 106E, between the various elements of system 100. Local memory 106 also may store an operating system (OS) 106B executable by processing device 104 that, after being initially loaded by a boot program, manages other programs in the computing device 102. OS 106B may employ graphical user interface windowing environment. An embodiment of OS 106B is a Windows® brand operating system sold by Microsoft Corporation, such as Windows® 95 or Windows NT® or other derivative versions of Windows®. However, other operating systems that provide windowing environments may be employed, such as the Macintosh OS from Apple Corporation and the OS/2 Presentation Manager from IBM. Memory 106 may store routines or programs executable by processing device 104, e.g., applications 106C or programs 106D. Applications 106C or programs 106D may make use of the OS 106B by making requests for services through a defined application program interface (API). Applications 106C or programs 106D may be used to enable the generation or creation of any application program designed to perform a specific function directly for a user or, in some cases, for another application program. Examples of application programs include word processors, calendars, spreadsheets, database programs, browsers, development tools, drawing, paint, and image editing programs, communication programs, tailored applications, and the like. Users may interact directly with computing device 102 through a user interface such as a command language or a user interface displayed on a monitor (not shown separately from computing device 102). At least a portion of local memory 106 may be comprised in one or more processing units, e.g., processing device 104.

Device interface 108 may be any one of several types of interfaces. Device interface 108 may operatively couple any of a variety of devices, e.g., hard disk drive, optical disk drive, magnetic disk drive, or the like, to the bus 112. Device interface 108 may represent either one interface or various distinct interfaces, each specially constructed to support the particular device that it interfaces to the bus 112. Device interface 108 may additionally interface input or output devices utilized by a user to provide direction to the computing device 102 and to receive information from the computing device 102. These input or output devices may include voice recognition devices, gesture recognition devices, touch recognition devices, keyboards, displays, monitors, mice, pointing devices, speakers, stylus, microphone, joystick, game pad, satellite dish, printer, scanner, camera, video equipment, modem, monitor, and the like (not shown). Device interface 108 may be a serial interface, parallel port, game port, firewire port, universal serial bus, or any other interface known to a person of ordinary skill in the art.

A person of ordinary skill in the art will recognize that the system 100 may use any type of computer readable medium accessible by a computer, such as magnetic cassettes, flash memory cards, compact discs (CDs), digital video disks (DVDs), cartridges, RAM, ROM, flash memory, magnetic disc drives, optical disc drives, and the like. A computer readable medium as described herein includes any manner of computer program product, computer storage, machine readable storage, or the like.

Network interface 110 may operatively couple computing device 102 to one or more server computing devices 102S, remote computing devices 102R, tablet computing devices 102T, mobile computing devices 102M, client computing devices 102C, and laptop computing devices 102L, on a local, wide, or global area network 130. Computing devices 102R or server computing devices 102S may be geographically remote from computing device 102 or client computing device 102C. Remote computing device 102R or server computing device 102S may have the structure of computing device 102 and may operate as server, client, router, switch, peer device, network node, or other networked device and typically includes some or all of the elements of computing device 102. Computing device 102 may connect to network 130 through a network interface or adapter included in the network interface 110. Computing device 102 may connect to network 130 through a modem or other communications device included in or coupled to network interface 110. Computing device 102 alternatively may connect to network 130 using a wireless device 132. The modem or communications device may establish communications to remote computing devices 102R through global communications network 130. A person of ordinary skill in the art will recognize that applications 106C or programs 106D may be stored, downloaded, or updated remotely through such networked connections. Network 130 may be local, wide, global, or otherwise and may include wired or wireless connections employing electrical, optical, electromagnetic, acoustic, or other carriers as is known to a person of ordinary skill in the art.

The present disclosure may describe some portions of the exemplary system 100 using algorithms and symbolic representations of operations on data bits within a memory, e.g., memory 106. A person of ordinary skill in the art will understand these algorithms and symbolic representations as most effectively conveying the substance of their work to others of ordinary skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated by physical devices, e.g., computing device 102. For simplicity, the present disclosure refers to these physical signals as bits, values, elements, symbols, characters, terms, numbers, or like. The terms are merely convenient labels. A person of ordinary skill in the art will recognize that terms such as computing, calculating, generating, loading, determining, displaying, or like refer to the actions and processes of a computing device, e.g., computing device 102. The computing device 102 may manipulate and transform data represented as physical electronic quantities within a memory into other data similarly represented as physical electronic quantities within the memory.

In an embodiment, system 100 may be a distributed network in which some computing devices 102 operate as servers, e.g., computing device 102S, to provide content, services, or the like, through network 130 to other computing devices operating as clients, e.g., client computing device 102C, remote computing device 102R, laptop computing device 102L, tablet computing device 102T. In some circumstances, distributed networks use highly accurate traffic routing systems to route clients to their closest service nodes.

In an embodiment, system 100 may include server computing device 102S and mobile computing device 102M as shown in FIG. 1B. Mobile computing device 102M may further include an image capture device 140 that captures an image 145 of any object, person, animal, place, scene, or the like. Image capture device 140 may include a digital camera and attendant processing circuitry as explained in more detail below.

FIG. 1C schematically illustrates block diagram of an exemplary image capture device 140, in accordance with some embodiments. Referring to FIGS. 1A-1C, image capture device 140 may include an image sensor array 142, a lens 144, and processor 146. Lens 144 may focus light from a subject on image sensor array 142. Processor 146 may control lens 144 and image sensor array 142 as is well known to a person of ordinary skill in the art. Image sensor array 142 may capture image 145 as a plurality of pixel values in response to actuation of a shutter release, switch, or button (not shown) by a user. Image capture device 140 may further include a memory 148 to store image 145. Memory 148 may be local to mobile computing device 102M (e.g., memory 106) or may be remote to mobile device 102M (e.g., memory 134 or 136) but accessible to mobile computing device 102M. Memory 148 may include any type, size, or configuration of memory known to a person of ordinary skill in the art, e.g., removable memory, non-volatile memory, volatile memory, or the like. Memory 148 may include flash, dynamic random access (DRAM), static random access memory (SRAM), content addressable memory, read only memory (ROM), or the like.

Image capture device 140 may store image 145 as an object or file in memory 148, according to predefined and standardized formats, e.g., Joint Photographic Experts Grout (JPEG), Graphics Interchange Exchange (GIF), raw, or the like. Within each file, image capture device 140 may arrange pixel values in a specific order, such as from left-to-right and from top-to-bottom. Mobile computing device 102M may display image 145 on a display based on the organization and pixel value order within the image object. An image object in accordance with a predefined format may contain pixel rows that extend horizontally relative to the orientation of image 145 when image 145 is eventually displayed on a display device (not shown) of mobile computing device 102M.

During or after capturing image 145, image capture device 140 may transfer the pixel values from image sensor array 142 to memory 148 for processing and/or storage, permanent or otherwise. This processing may involve arranging or formatting the pixel values into image 145 that conforms to a predefined standard format, e.g., JPEG, GIF, or the like. Image capture device 140 may compress or format the pixel values from image sensor array 142. Image capture device 140 may transfer the compressed or formatted pixel values as image 145 to removable memory 148 for storage therein. Processor 146 may access memory 148. In some embodiments, memory 148 may part of a removable storage device capable of being removed from image capture device 140 (or mobile computing device 102M) by a user and plugged into another computing device 102, e.g., remote computing device 102R, for further viewing or downloading of images stored thereon.

In an embodiment, image capture device 140 may include an orientation sensor 150 to indicate an orientation of the image sensor array 142 when an image is captured. Orientation sensor 150 may indicate whether the image capture device 140 (or mobile computing device 102M) is being held by a user in a landscape orientation or in a rotated, portrait orientation that is 90° from the landscape orientation. Orientation sensor 150 may enable processor 146 to automatically digital rotate captured images to correct for different orientations of image sensor 142.

Processor 146 may control the operation of lens 144, image sensor array 142, memory 148, orientation sensor 150, or any combination thereof. Processor 146 may be any processing device of any size, type, or configuration known to a person of ordinary skill in the art.

Server computing device 102S may include an image file manager 160 and remote memory 134 to store image file 145 uploaded from mobile device 102M using global network 130. Mobile computing device 102M may be geographically remote from server computing device 102S but electrically coupled to server computing device 102S through, e.g., global computing network 130. Server computing device 102S may provide computing, content, services, or the like, through network 130 to mobile computing device 102M. In some instances, server computing device 102S may store, manage, and process image files for mobile computing device 102M rather than mobile computing device 102M storing, managing, and processing image files locally. In an embodiment, a user of mobile computing device 102M may subscribe to one or more user accounts 162 on server computing device 102S for free, for a fee, or for other consideration, e.g., the viewing of sponsored ads or other content as is well known to a person of ordinary skill in the art.

Server computing device 102S may host user accounts 162 as is well known to a person of ordinary skill in the art. User account 162 may allocate a predetermined amount of storage to a user, e.g., 5 Gb, 10 Gb, and the like in any memory or storage device in system 100, e.g., system memory 106, remote memory 134, or external memory 136. User accounts 162 may be tiered such that the amount of storage that image file manager 160 allocates to each account 162 may vary based on the tier level of the user's subscription. For example, image file manager 160 may allocate 5 Gb of storage to user account 162 to a first (free) tier level while allocating 10 Gb of storage to another user account 162 to a second (fee) tier level. Server computing device 102S may receive image file 145 from mobile computing device 102M through network 130 and store image file 145 in association with user account 162. Server computing device 102S may host any number of user accounts 162, as is well known to those of ordinary skill in the art.

A user may subscribe or have access to one or more user accounts 162 of any type. In an embodiment, a user may subscribe to a personal account, a business account, or both a personal account and a business account as explained in more detail below. A personal account may be dedicated to the user's personal file storage in contrast to a business account that is dedicated to business file storage. A file storage service for a personal account may be set up, paid for, or otherwise controlled by the user. In contrast, a file storage service for a business account may be set up, paid for, and other paid for, or otherwise controlled a business entity, e.g., the user's employer, the user's business, or the like.

Server computing device 102S may receive image 145 from mobile computing device 102M through network 130. Server computing device 102S may include image file manager 160 to process image 145. Server computing device 102S may further include or have access to applications 106C or programs 106D, e.g., calendar, contacts, social media, or camera roll, resident on mobile computing device 102M. In some embodiments, server computing device 102S may request access to applications 106C or programs 106D on mobile computing device 102M. A person of ordinary skill in the art should recognize that one or more of applications 106C or programs 106D may be executing on computing devices other than server computing device 102S, e.g., computing device 102R, that may be coupled to server computing device 102S through known mechanisms, e.g., network 130.

FIG. 1D schematically illustrates block diagram of an exemplary image file manager 160, in accordance with some embodiments. Referring to FIGS. 1A-1D, server computing device 102S may include an image file manager 160 to receive image file 145 uploaded from mobile computing device 102M via network 130. Image file manager 160 may determine an image capture context 180 by analyzing metadata 147 included in image file 145. Image capture context may include any parameter or other information about image 145 including information specific to the capture of image 145. In an embodiment, image capture context 180 may include date and time of capture of image 145, location of image capture device 140 during capture of image 145, whether capture of image 145 occurred in connection with calendar event, or the like.

Metadata 147 may provide information or data about image file 145, e.g., time of capture, location of capture, image capture device settings at a time of image capture, or the like. In an embodiment, image capture device 140 may write metadata 147 into image file 145 to identify the owner of image file 145, copyright, or other contact information. Metadata 147 may further identify the type, brand, or model of image capture device 140 or mobile device 102M, along with exposure information, e.g., shutter speed, f-stop, or the like. Metadata 147 may include descriptive information about image file 145, e.g., keywords about the image, that allow for searching for image file 145 on mobile computing device 102M or server computing device 102S.

In some instances, image capture device 140 may automatically create metadata 147 at image capture. In other instances, a user may manually enter metadata, e.g., descriptive tags, that image capture device 140 or mobile computing device 102M may associate or include in image file 145. In yet other instances, imaging software operating on mobile computing device 102M may generate metadata 147 to associate or include with image file 145. Metadata 147 may ease image file 145 organization, post-production filtering or editing, or the like. Metadata 147 may be governed by standards promulgated by organizations, e.g., International Press Telecommunications Council (IPTC), Extensible Metadata Platform (XMP), Exchangeable Image File Format (EXIF), or the like, as is well known to a person of ordinary skill in the art.

Server computing device 102S may include remote memory storage 134 coupled to image file manager 160. Remote storage 134 may be any kind of memory, volatile or non-volatile, removable or non-removable, known to a person of ordinary skill in the art including non-volatile memory, volatile memory, random access memory (RAM), flash memory, read only memory (ROM), ferroelectric RAM, magnetic storage devices, optical discs, or the like. Remote memory 134 may include one or more individual memory devices of any type. Remote memory 134 may be integral or external to server computing device 102S.

Remote memory storage 134 may store image file 145 in one or more of a plurality of user accounts, e.g., a user accounts 162A and 162B, corresponding to a plurality of users 161A and 161B, respectively. A single user, e.g., user 161A, may have access to one or more user accounts, e.g., user account 162A. In an embodiment, user 161A may have access to one or more types of user accounts, e.g., user 161A may have access to a business account 164A or a personal account 166A or a combination of both business account 164A and personal account 166A. A person of ordinary skill in the art should recognize that a single user may have access to any number or type of user accounts including business and personal accounts. Although only two users 161A and 161B are shown in FIG. 1D, a person of ordinary skill in the art should recognize that any number of users may have access to any number of accounts of any type including personal accounts, business accounts, or otherwise. Additionally, FIG. 1D shows only two account types, e.g., business accounts 164A and 164B and personal accounts 166A and 166B corresponding to users 161A and 161B, respectively, but any number of account types come within the scope of the disclosure.

A user account 162 may be a logical construct provided by the cloud file storage service that divides or allocates portions of remote memory storage 134 to subscriber users 161A and 161B and/or to user accounts 162A and 162B. In an embodiment, user 161A may have access to a business account 164A through his business or employer that has a predetermined amount of memory 134 for the storage of images 145 categorized by image file manager 160 as business images 168A based on image capture context 180. User 161A may have additional access to a personal account 166A that has a predetermined amount of memory 134 for the storage of images 145 categorized by image file manager 160 as personal images 170A based on image capture context 180.

Likewise, user 161B may have access to a business account 164B through her business or employer that has a predetermined amount of memory 134 for the storage of images 145 categorized by image file manager 160 as business images 168B based on image capture context 180. User 161B may have additional access to a personal account 164B that has a predetermined amount of memory 134 for the storage of images 145 categorized by image file manager 160 as personal images 170B based on image capture context 180.

In an embodiment, image file manager 160 may temporarily store image file 145 after receiving image file 145 from mobile computing device 102M for analysis before permanently storing image file 145 into one of the user accounts, e.g., user account 162A.

In an embodiment, user accounts 162A or 162B may be private, secured accounts, accessed only after proper authentication by server computing device 102S. Server computing device 102S may receive authentication information 151 from mobile computing device 102M that server computing device 102S uses to authenticate access to a particular user account, e.g., user account 162A. For simplicity, we refer to user account 162A but server computing device 102S may authenticate users and provide access to any number of user accounts including user accounts 162A or 162B.

Authentication information 151 may include any type of information necessary to authenticate access user accounts 162 known to a person of ordinary skill in the art, e.g., user name, user email, password, challenge questions and answers, personal identification numbers, knowledge based questions and answers, and the like. In an embodiment, some of the authentication information 151 may have been provided or set up by a user at initiation of the subscription. Server computing device 102S may employ any protocol or standard to secure user accounts 162 known to a person of ordinary skill in the art. Once the user is authenticated, server computing device 102S may provide access to a user accounts 162.

Image file manager 160 may receive image file 145 for permanent storage into a user account, e.g., user accounts 162A or 162B, on remote memory 134. Image file manager 160 may determine image capture context 180 for image file 145 by analyzing metadata 147. Image capture context 180 may include date and time of capture of image 145, location of image capture device 140 during capture of image 145, whether capture of image 145 occurred in connection with a calendar event, and the like. Image file manager 160 may identify an image type corresponding to image 145 based at least in part on the image capture context 180. In an embodiment, image file manager 160 may associate the image capture context 180 with image 145 by, e.g., adding metadata 167 corresponding to image 145. Image file manager 160 may add metadata 167 corresponding to image 145 before or after storing or saving image file 145 to a particular user account 162.

In an embodiment, image file manager 160 may determine that it has received image file 145 from a user 161A after authenticating user 161A using authentication information 151. Image file manager 160 may determine an image type of image file 145 by analyzing metadata 147. Image file manager may determine that image file 145 is a business image after determining that image file 145 was taken during work hours or at work location or at work meeting based on image capture context 180. Image file manager 160 may modify, amend, add, or otherwise annotate metadata 167 to indicate that image file 145 is a business image 168A. Image file manager 160 may then store image file 145 as business image 168A in business account 164A of user 161A. In an embodiment, business image 168A may include a modified or annotated metadata 167 that includes the image's type as a business image.

In another embodiment, image file manager 160 may determine that it has received image file 145 from a user 161B after authenticating user 161B using authentication information 157. Image file manager may determine an image type of image file 145 by analyzing metadata 147. Image file manager 160 may determine that image file 145 is a personal image after determining that image file 145 was not taken during work hours or at work location or at a work meeting based on image capture context 180. Image file manager 160 may modify, amend, add, or otherwise annotate metadata 167 to indicate that image file 145 is a personal image 170B. Image file manager 160 may then store image file 145 as personal image 170B in personal account 166B of user 161B. In an embodiment, personal image 170B may include a modified or annotated metadata 167 that includes the image's type as a personal image.

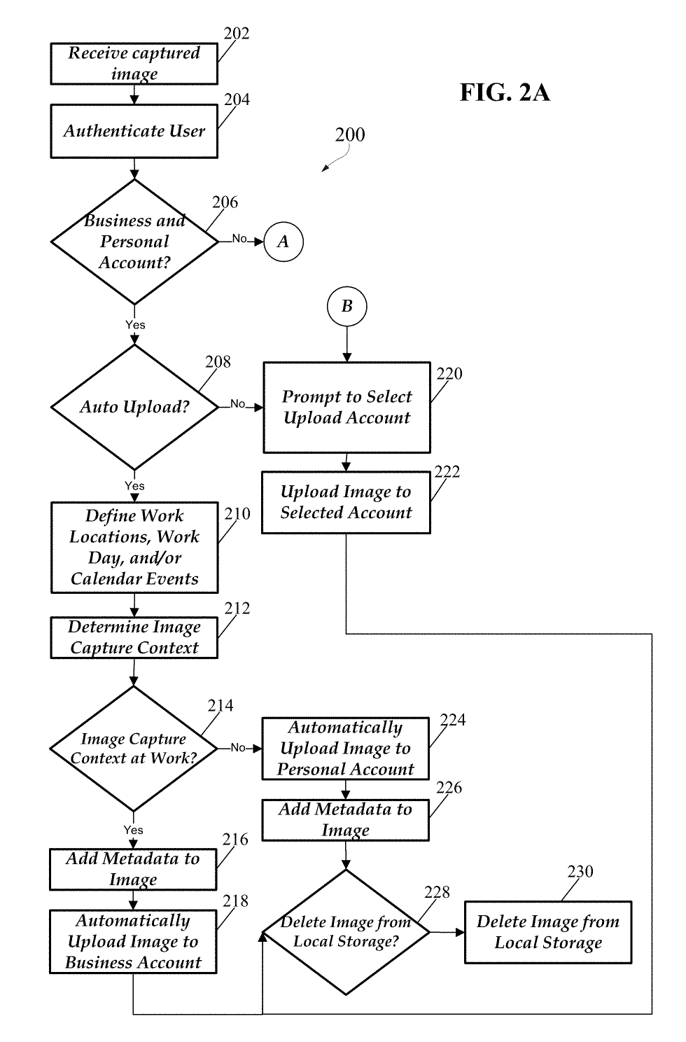

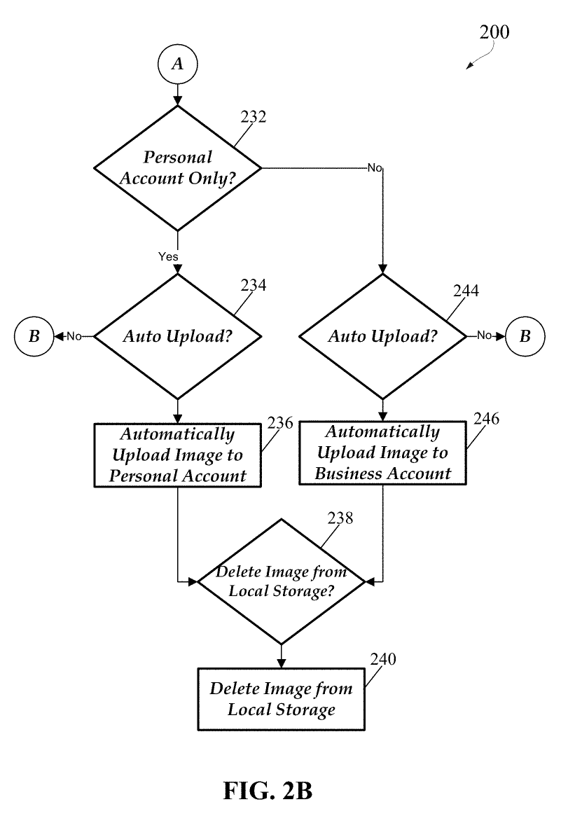

FIGS. 2A and 2B illustrate a block diagram of an exemplary method 200 for automatically uploading image files based on image capture context 180, in accordance with some embodiments. Referring to FIGS. 1A-1D and 2A and 2B, at 202, method 200 may receive image 145 at server computing device 102S captured using mobile computing device 102M, and transmitted from mobile computing device 102M to server computing device 102S via network 130. Mobile computing device 102M may capture image 145 using image capture device 140. Image capture device 140 may encode, add, or otherwise include metadata 147 with image 145. Metadata 147 may include certain image context parameters or characteristics of image 145 at the time of image capture, e.g., date of image capture, time of image capture, location of image capture, image capture settings, and the like.

At 204, method 200 may identify and authenticate a user, e.g., user 161A, of a file hosting service to determine the types of accounts associated with user 161A. In an embodiment, method 200 may determine whether user 161A is associated with business account 164A, personal account 166A, or both business account 164A and personal account 166A. A person of ordinary skill in the art should recognize that user 161A may be associated with any number of accounts of any type. The disclosure describes a single user having access to two account types, business and personal, for simplicity only.

At 206, method 200 determines whether user 161A has access to two or more account types, e.g., both business account 164A and personal account 164B.

If yes, method 200 determines whether user 161A has turned on automatic uploading of images at 208. User 161A may turn on automatic uploading with a setting on the file hosting service at, e.g., server computing device 102S, or a setting on mobile computing device 102M, as is well known to a person of ordinary skill in the art. Automatic uploading of images may be, in some embodiments, the default setting at the file hosting service executing on server computing device 102S or at the mobile computing device 102M.

If automatic uploading is turned on, method 200 determines, looks up, or otherwise defines predetermined image context parameters, e.g., work locations, work day hours, and/or calendar events, at 210. In an embodiment, method 200 may determine image context parameters by determining settings on the file hosting server at, e.g., server computing device 102S or at mobile computing device 102M.

At 212, method 200 determines an image capture context 180 by analyzing, decoding, or otherwise deciphering metadata 147 and comparing metadata 147 to the image context parameters. In an embodiment, method 200 may compare the time of image capture included in metadata 147 with work day hours or method 200 may compare the location of image capture included in metadata 147 with work locations. Further still, method 200 may determine that the time or date of image capture or the location of image capture included in metadata 147 is coincident with a scheduled event, e.g., a work meeting at a particular meeting location. To do so, method 200 may have access to any number of applications or other software operating at mobile computing device 102M as is well known to a person of ordinary skill in the art.

At 214, method 200 may determine whether image 145 is a work or business related image by comparing or otherwise analyzing metadata 147 against image context parameters at server computing device 102S or mobile computing device 102M.

If image 145 is work or business related, method 200 may change or otherwise add metadata 167 of image 145 to indicate that image 145 is a business or work image 168A at 216.

At 218, method 200 may automatically upload and store image 145 to business account 164A as business image 168A without any intervention from user 161A.

At 224, method 200 may automatically upload and store image 145 to personal account 166A as personal image 170A without any intervention from user 161A.

If image 145 is not work or business related, method 200 may change, add, or otherwise modify metadata 167 of image 145 to indicate that image 145 is a personal image 170A at 226.

At 228, method 200 may determine whether to cause deletion of image 145 from mobile computing device 102M by, e.g., determining deletion settings in file hosting service at server computing device 102S or mobile computing device 102M. Method 200 may prompt user 161A to confirm deletion of image file 145 from local memory 106 of mobile computing device 102M using, e.g., a graphical user interface displayed on mobile computing device 102M.

At 230, method 200 may cause substantial or permanent deletion of image 145 from local memory 106 mobile computing device 102M.

If automatic uploading is turned off at 208, method 200 may prompt user 161A to determine or ascertain the account to upload image 145 at 220. Method 200 may prompt user 161A to identify the account type in which to store or save image 145 using, e.g., a graphical user interface displayed on mobile computing device 102M.

At 222, method 200 may upload or store image 145 to the account type identified at 220. Method 200 may optionally prompt user 161A for deletion instructions at 228 and 230 as explained previously.

If user 161A does not have both a personal and business account, method 200 determines whether user 161A has a personal account only or a business account only at 232.

If user 161A has a personal account only, at 234, method 200 determines whether user 161A has turned on automatic uploading of images. User 161A may turn on automatic uploading with a setting on the file hosting service at, e.g., server computing device 102S, a setting on mobile computing device 102M, or a setting on an application executing on the mobile computing device 102M, as is well known to a person of ordinary skill in the art. Automatic uploading of images may, in some embodiments, be the default setting at the file hosting service on server computing device 102S or at the mobile computing device 102M.

If automatic uploading is turned on at 234, method 200 automatically uploads and stores image 145 to personal account 166A without any intervention from a user. In an embodiment, method 200 may or may not determine the image capture context of image 145 and may or may not modify metadata 167 to identify image 145 as a personal image since such a distinction may not be necessary given that user 161A only has access to a personal account 166A. If automatic uploading is turned off at 234, method may prompt the user to select or otherwise identify an account to store image 145 at 220 and 222.

At 242, method 200 determines that user 161A only has access to a business account type.

If user 161A does not have a personal account only at 232, user 161A must have a business account only. In this circumstance, at 244, method 200 determines whether user 161A has turned on automatic uploading of images. If automatic uploading is turned on at 244, method 200 automatically uploads and stores image 145 to business account 164A without any intervention from user 161A. In an embodiment, method 200 may or may not determine the image capture context of image 145 and may or may not add metadata 167 to identify image 145 as a business image since such a distinction may not be necessary given that user 161A only has access to a business account 164A. If automatic uploading is turned off at 244, method may prompt the user to select or otherwise identify an account type or an account to store image 145 at 220 and 222.

At 236, method 200 may automatically upload and store image 145 to personal account 166A without any intervention from user 161A.

At 246, method 200 may automatically upload and store image 145 to business account 164A without any intervention from user 161A.

At 238, method 200 may determine whether to cause deletion of image 145 from mobile computing device 102M by, e.g., determining deletion settings in file hosting service at server computing device 102S or mobile computing device 102M. Method 200 may prompt user 161A to confirm deletion of image file 145 from local memory 106 of mobile computing device 102M using, e.g., a graphical user interface displayed on mobile computing device 102M.

At 240, method 200 may cause substantial or permanent deletion of image 145 from local memory 106 of mobile computing device 102M.

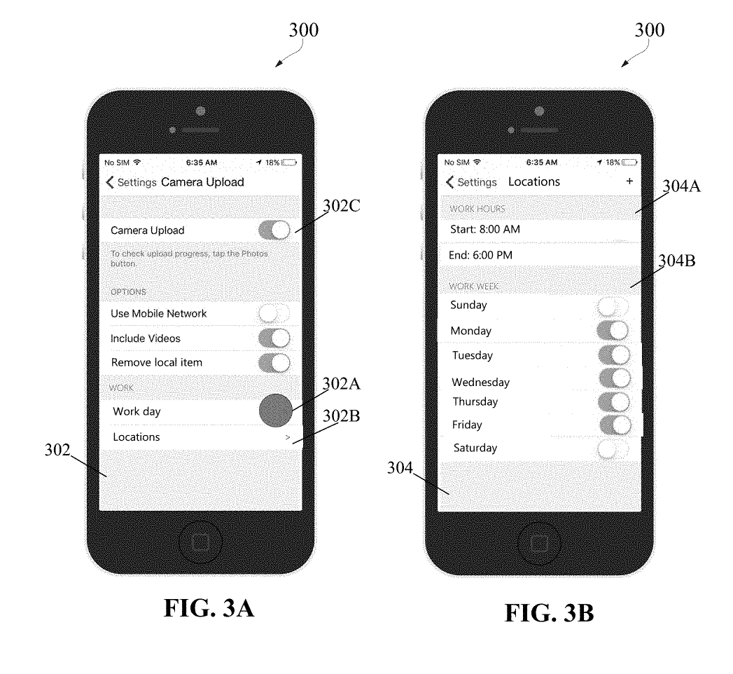

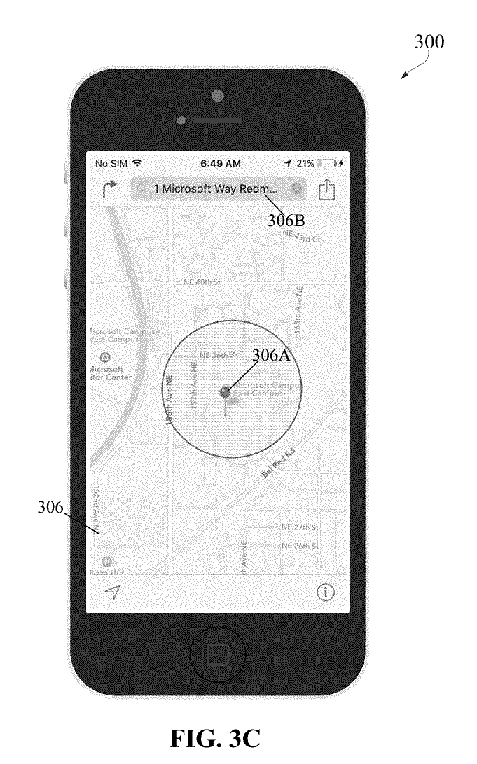

FIGS. 3A-3C illustrate an exemplary graphical user interface (GUI) 300 for automatically uploading image files based on image capture context as implemented in computer system 100, in accordance with some embodiments. Referring to FIGS. 1A-1D and 3A-3C, GUI 300 may be presented to a user on any computing device 102 using any means known to a person of ordinary skill in the art. GUI 300 may be implemented as an application program written in a conventional programming language, using the extensive built-in graphic capabilities of the Windows® operating environment. The application program is typically stored on and executes from any type of computer-readable storage medium or memory discussed above in relation to FIGS. 1A-1D.

GUI 300 may have several distinct display regions or windows, e.g., display regions 302A, 302B, and 302C of a screen 302 to establish any number or type of image context parameters. For example, display region 302A may allow user 161A or 161B to establish his work day while display region 302B may allow user 161A or 161B to establish his work locations. Display region 302C may allow user 161A or 161B to turn on or off automatic image upload by any graphical means known to a person of ordinary skill in the art including, sliders, popup menus, icons, or the like.

At display region 304A of a screen 304, user 161A or 161B may establish work hours, e.g., start work time and end work time. User 161A or 161B may establish work hours by any graphical means known to a person of ordinary skill in the art including, sliders, popup menus, icons, or the like.

At display region 304B of screen 304, user 161A or 161B may establish work days in a week, e.g., Monday through Friday, exclusive of Saturday and Sunday. User 161A or 161B may establish work days by any graphical means known to a person of ordinary skill in the art including, sliders, popup menus, icons, or the like.

At display region 306A of a screen 306, user 161A or 161B may establish work locations by any graphical means known to a person of ordinary skill in the art including, sliders, popup menus, icons, or the like. In an embodiment, user 161A or 161B may establish a work location by, e.g., dropping a pin on a map or direction application as is well known to a person of ordinary skill in the art. User 161A or 161B may establish a work location by entering one or more work location addresses in any manner known to a person of ordinary skill in the art including by entering the address at region 306B.

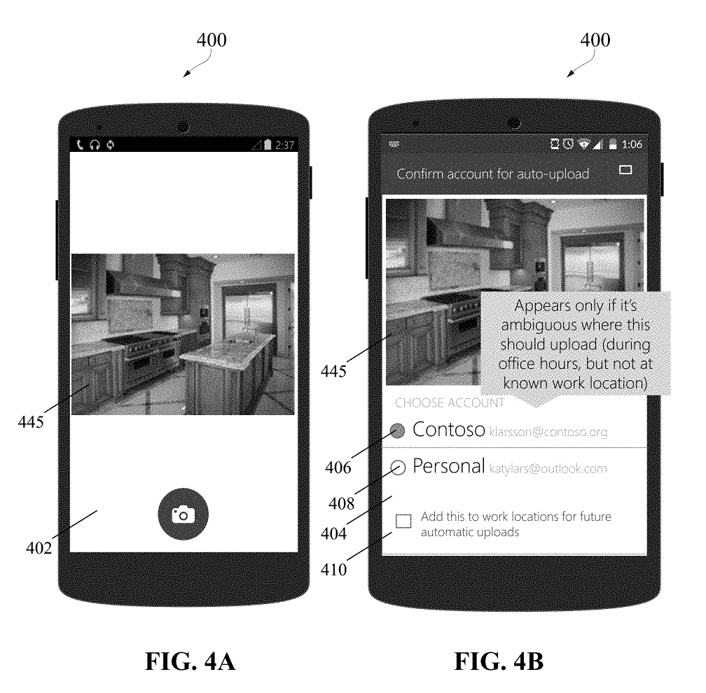

FIGS. 4A and 4B illustrates an exemplary graphical user interface (GUI) 400 for automatically uploading image files based on image capture context, in accordance with some embodiments. Referring to FIGS. 1A-1D, 4A, and 4B, GUI 400 may display an image 445 at a screen 402 of a computing device, e.g., mobile computing device 102M. GUI 400 may display a screen 404 to confirm account for automatically uploading image in a circumstance in which image context parameters of image 445 do not clearly indicate that the image is a business or a personal type of image. For example, GUI 400 may display a screen 404 to confirm whether the image should be automatically uploaded to a business account at 406 or a personal account at 408 where image context parameters for image 445 indicate that the image was captured during work hours but at a location that is not identified as a work location. In this circumstance, user 161A or 161B may manually select the account type at 406 or 408 using any graphical means known to a person of ordinary skill in the art including, sliders, popup menus, icons, or the like. Optionally, user 161A or 161B may use graphical device 410, e.g., a check box, to indicate that the location at which image 445 was captured is a work location for future use.

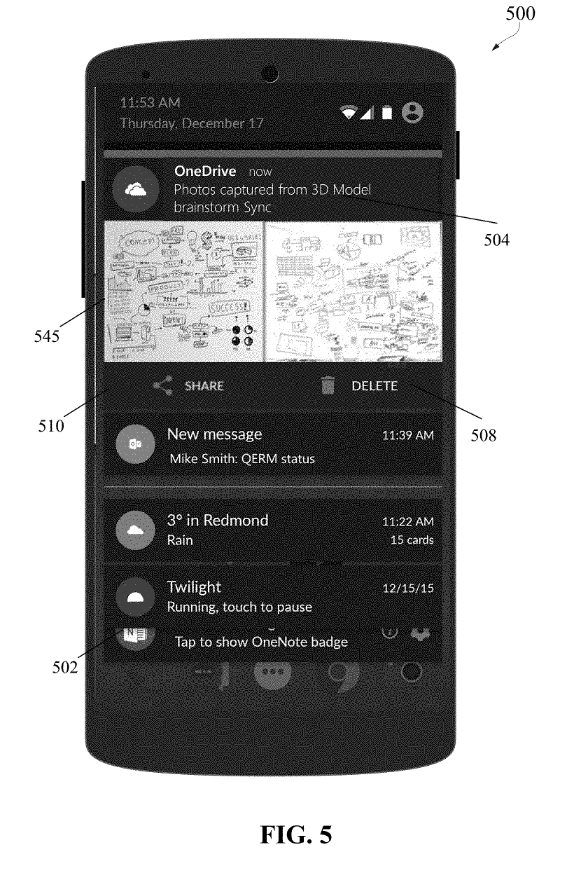

FIG. 5 illustrates an exemplary graphical user interface (GUI) 500 for automatically uploading image files based on image capture context, in accordance with some embodiments. Referring to FIG. 5, GUI 500 may include a screen 502 that identifies the image files 545 stored in each account of the file storing service. In an embodiment, GUI 500 may display files 545 as well as identifying information about the image capture context at display region 504. GUI 500 may provide user 161A or 161B the ability to delete the image at 508 or share the image at 510.

It will also be appreciated by persons of ordinary skill in the art that the present disclosure is not limited to what has been particularly shown and described hereinabove. Rather, the scope of the present disclosure includes both combinations and sub-combinations of the various features described hereinabove as well as modifications and variations which would occur to such skilled persons upon reading the foregoing description. Thus the disclosure is limited only by the appended claims.

1. A system, comprising:
a memory device to store instructions; and
at least one processing device to execute the instructions stored in the memory device to:
determine an image capture context for an image;
identify an image type corresponding to the image based at least in part on the image capture context;
associate the image type with the image; and
automatically store a copy of the image on a remote memory device based at least in part on the image type.

2. The system of claim 1, wherein the at least one processing device executes the instructions stored in the memory device further to:
associate the image type with a corresponding account type at the remote memory device; and
automatically store the copy of the image in association with the corresponding account type on the remote memory device.

3. The system of claim 2, wherein the at least one processing device executes the instructions stored in the memory device further to:
store application metadata identifying the image type and the account type; and
automatically store the copy of the image in association with the corresponding account type on the remote memory device based on the metadata.

4. The system of claim 1, wherein the at least one processing device executes the instructions stored in the memory device further to:
identify the image type as a business type or a personal type; and
automatically store the copy of the image in association with an account type in the remote location account corresponding to the business type or the personal type.

5. The system of claim 4, wherein the at least one processing device executes the instructions stored in the memory device further to:
graphically display an image type icon to switch the image type from the business type to the personal type or vice versa.

6. The system of claim 1, wherein the at least one processing device executes the instructions stored in the memory device further to:
store the image at least temporarily in a local memory device after capturing the image; and
delete the image from the local memory device after automatically storing a copy of the image on the remote memory device.

7. The system of claim 5, wherein the remote memory device is located geographically remote from the local memory device.

8. The system of claim 1, wherein the at least one processing device executes the instructions stored in the memory device further to:
graphically display a confirmation icon to confirm the automatic storage of the copy of the image.

9. A method comprising:
determining, at a processing device, an image capture context for an image;
identifying, at the processing device, an image type corresponding to the image based at least in part on the image capture context;
generating, by the processing device, an enhanced image by including the image type in the image; and
transmitting the enhanced image from the processing device to a remote memory device for automatic storage of the enhanced image on the remote memory device based at least in part on the image type.

10. The method of claim 9, further comprising:
associating, by the processing device, the image type with a corresponding account type at the remote memory device; and
transmitting the enhanced image from the processing device to the remote memory device for automatic storage of the enhanced image on the remote memory device in association with the corresponding account type.

11. The method of claim 10, further comprising:
identifying, by the processing device, the enhanced image by including the account type.

12. The method of claim 10, further comprising:
identifying, by the processing device, the image type as a business type or a personal type; and
transmitting the enhanced image from the processing device to the remote memory device for automatic storage of the enhanced image on the remote memory device in association with an account corresponding to the business type or the personal type.

13. The method of claim 12, further comprising:
graphically displaying, by the processing device, an image type icon to switch the image type from the business type to the personal type or vice versa; and
modify the enhanced image based at least in part on receiving an indication of actuation of the image type icon.

14. The method of claim 9, further comprising:
storing the image or the enhanced image at least temporarily in a local memory device after capturing the image; and
delete the image from the local memory device after transmitting the enhanced image for automatic storage of the enhanced image in the remote memory device.

15. A computer-readable storage medium comprising instructions that, when executed by one or more processing devices, cause the one or more processing devices to:
determine an image capture context for an image;
identify an account type and an image type corresponding to the image based at least in part on the image capture context;
generate an enhanced image by including the image type in the image; and
transmit the enhanced image to a remote memory device for automatic storage of the enhanced image on the remote memory device based at least in part on the account type.

16. The computer-readable storage medium of claim 15, wherein execution of the instructions by the one or more processing devices, cause the one or more processing devices further to:
determine the image capture context for the image from metadata associated with the image.

17. The computer-readable storage medium of claim 15, wherein execution of the instructions by the one or more processing devices, cause the one or more processing devices further to:
modify the enhanced image by including the account type.

18. The computer-readable storage medium of claim 15, wherein execution of the instructions by the one or more processing devices, cause the one or more processing devices further to:
identify the image type as a business type or a personal type; and
transmit the enhanced image to the remote memory device for automatic storage of the enhanced image on the remote memory device in association with an account corresponding to the business type or the personal type.

19. The computer-readable storage medium of claim 18, wherein execution of the instructions by the one or more processing devices, cause the one or more processing devices further to:
graphically display an image type icon to switch the image type from the business type to the personal type or vice versa; and
modify the enhanced image based at least in part on receiving an indication of actuation of the image type icon.

20. The computer-readable storage medium of claim 15, wherein execution of the instructions by the one or more processing devices, cause the one or more processing devices further to:
store the image or the enhanced image at least temporarily in a local memory device after capturing the image; and
delete the image or the enhanced image from the local memory device after transmitting the enhanced image for automatic storage of the enhanced image in the remote memory device.
